(19) United States
(12) Patent Application Publication
(10) Pub. No.: US 2019/0337249 A1
(43) Pub. Date: Nov. 7, 2019

(54) TIRE DISTORTION DETECTION METHOD AND GREEN TIRE INCLUDING PORTION TO BE DETECTED

(71) Applicant: TOYO TIRE CORPORATION, Itami-shi (JP)

(72) Inventor: Koji Arakawa, Itami-shi (JP)

(73) Assignee: TOYO TIRE CORPORATION, Itami-shi (JP)

(21) Appl. No.: 16/390,507

(22) Filed: Apr. 22, 2019

(30) Foreign Application Priority Data
May 7, 2018 (JP) 2018-089099

(51) Int. Cl. B29D 30/00; G01N 3/08

(52) U.S. Cl. CPC B29D 30/0061; G01N 3/068; B29D 2030/0066; G01N 3/08

(57) ABSTRACT

A tire distortion detection method includes a first step of forming a metallic portion to be detected in a plurality of locations of at least one of tire components, a second step of detecting the portion to be detected in any two states including before and after a manufacturing process for obtaining a product tire from a plurality of tire components including the above tire components, and a third step of comparing positions of the respective portions to be detected in the two states obtained in the second step.

### CROSS-REFERENCE TO RELATED APPLICATIONS

This application claims priority of Japanese Patent Application No. 2018-089099 filed on May 7, 2018, the content of which is incorporated herein by reference.

### BACKGROUND OF THE INVENTION

### Technical Field

The present invention relates to a tire distortion detection method and a green tire including a portion to be detected.

### Related Art

Conventionally, an observation method of the inside of a tire, in which a tire is irradiated with an X-ray to detect a steel cord in the tire, has been publicly known (for example, see JP 2006-308316A).

However, with the conventional method, it is only possible to detect the deformation and behavior of a steel cord in a tire. It is impossible to detect distortion occurring inside the tire.

### SUMMARY

It is an object of the present invention to provide a tire distortion detection method which makes it possible to detect distortion inside a tire which has conventionally been difficult to detect and a green tire including a portion to be detected.

As means for achieving the above object, according to the present invention, there is provided a tire distortion detection method, including a first step of forming a metallic portion to be detected in a plurality of locations of at least one of tire components, a second step of detecting the portion to be detected in any two states from a formation of a product tire from the tire component to a change of a load condition on the product tire, and a third step of comparing positions of the respective portions to be detected in the two states obtained in the second step.

The second step preferably includes a green tire formation process of assembling a plurality of tire components including the above tire component to form a green tire, and a product tire formation. process of forming a product tire by vulcanizing and molding the green tire, and, in the third step, positions of respective portions to be detected that are detected after completion of the green tire formation process and the product tire formation process are preferably compared.

The second step preferably includes a product tire formation process of vulcanizing and molding the green tire to form a product tire, and, in the third step, a position of each portion to be detected that is detected when a product tire obtained in the product tire formation process is in a no-load state, and a position of each portion to be detected that is detected when a product tire is inflated by increasing an air pressure in internal space of the product tire are preferably compared.

The portions to be detected are preferably formed in a dotted or linear shape and arranged at predetermined intervals.

The tire component preferably includes a plurality of tire cords provided in parallel at predetermined intervals, and the portions to be detected are preferably provided in parallel in a direction orthogonal to a direction in which the tire cord extends, and preferably extend in a dotted or linear shape in a direction along the tire cord.

The tire component preferably includes a plurality of tire cords provided in parallel at predetermined intervals, and the portions to be detected are preferably provided in parallel in a direction in which the tire cord extends, and preferably extend in a dotted or linear shape in a direction orthogonal to a direction in which the tire cord extends.

As a means for achieving the above object, according to the present invention, there is provided a green tire having a tire component in which a metal portion to be detected that is detectable by detecting means is formed in a plurality of locations.

According to the present invention, it is possible to detect distortion inside a tire which has conventionally been difficult to detect.

### BRIEF DESCRIPTION OF THE DRAWINGS

The foregoing and the other features of the present invention will become apparent from the following description and drawings of an illustrative embodiment of the invention in which;

FIG. 1 is a meridian half cross-sectional view of a green tire according to the present embodiment;

FIG. 2 is a front view of a tire support device according to the present embodiment;

FIG. 3 is an enlarged view of FIG. 2;

FIG. 4 is a plan view of a support base shown in FIG. 2;

FIG. 5 is a side view of a load application member shown in FIG. 2.

FIG. 6 is a partial plan view showing an example in which a portion to be detected is provided in a tire component;

FIG. 7 is a partial plan view showing an example in which a portion to be detected is provided in a tire component;

FIG. 8 is a partial plan view showing an example in which a portion to be detected is provided in a tire component;

FIG. 9 is a partial plan view showing an example in which a portion to be detected is provided in a tire component;

FIG. 10 is a partial plan view showing an example in which a portion to be detected is provided in a tire component;

FIG. 11 is a partial plan view showing an example in which a portion to be detected is provided in a tire component;

FIG. 12 is a partial plan view showing an example in which a portion to be detected is provided in a tire component;

FIG. 13 is a schematic view showing part of an image of the green tire obtained by imaging by the X-ray CT device shown in FIG. 2; and

FIG. 14 is a partial schematic vie showing a change of a portion to be detected before and after deformation of the green tire obtained by the imaging by the X-ray CT device shown in FIG. 2.

### DETAILED DESCRIPTION OF EMBODIMENTS

Hereinafter, embodiments according to the present invention will be described with reference to the accompanying drawings. It should be noted that description below is merely exemplary in nature and is not intended to limit the invention, its application, or its use. Note that the drawings are schematic, and ratios of dimensions and the like are different from actual ones.

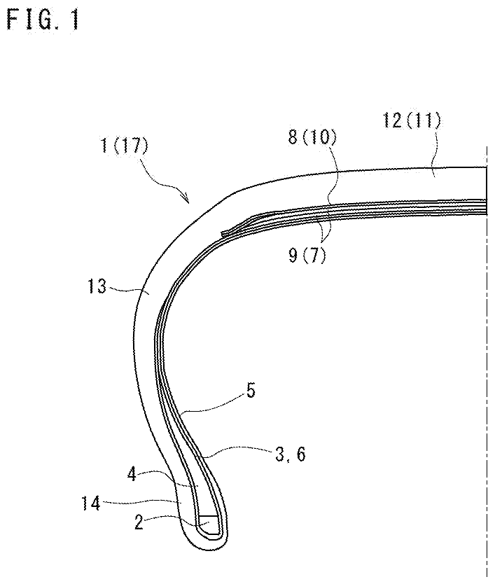

FIG. 1 is a meridian half cross-sectional view of a green tire 1 according to the present embodiment. In the green tire 1, a carcass 3 is stretched between a pair of bead cores 2 (one of them is not shown).

A bead filler 4 is connected to the bead core 2, and both end sides of the carcass 3 are rolled up there. An inner liner 5 is provided on an inner side in a tire radial direction of the carcass 3.

The carcass 3 includes at least one carcass ply 6 (here, one). The carcass ply 6 is configured with a plurality of carcass cords arranged at predetermined intervals and coating rubber covering these carcass cords. For the carcass cord, for example, organic fiber cords of rayon, aramid, polyester and the like are used. The carcass cord extends in a direction substantially orthogonal to a tire circumferential direction of the green tire 1.

On an outer side in the tire radial direction of the carcass 3, a belt layer 7 and a belt reinforcing layer 8 are arranged in this order.

The belt layer 7 includes a plurality of (here, two) belts 9. Each of the belts 9 is configured with a plurality of belt cords arranged at predetermined intervals and coating rubber covering the belt cords. For the belt cord, a steel cord is used. The belt cord extends obliquely with respect to the tire circumferential direction. Between the belts 9, inclination directions of the belt cords are different.

The belt reinforcing layer 8 includes at least one (here, one cap ply 10. The cap ply 10 is configured with a plurality of cap ply cords arranged at predetermined intervals and coating rubber covering these cap ply cords. For the cap ply cord, an organic fiber cord of polyester or the like is used. The cap ply cord extends in the tire circumferential direction.

On an outer side in the tire radial direction of the belt reinforcing layer 8, tread rubber 12 that becomes a tread portion 11 after vulcanization and molding is provided.

A rubber layer is provided from the tread rubber 12 toward the bead core 2, so that a side wall portion 13 and then a bead portion 14 are formed.

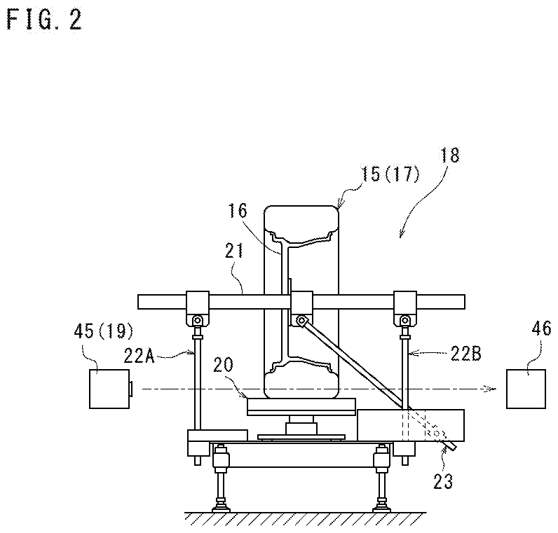

The green tire 1 having the above configuration is vulcanized and molded into a product tire 15. As shown in FIG. 2, a wheel 16 is mounted on the product tire 15, and inner space is filled with air (hereinafter, the green tire 1 and the product tire 15 will be collectively referred to simply as a tire 17, in some cases).

FIG. 2 shows a tire distortion detection device according to the present embodiment. This tire distortion detection device includes a tire support device 18 and an X-ray CT device 19.

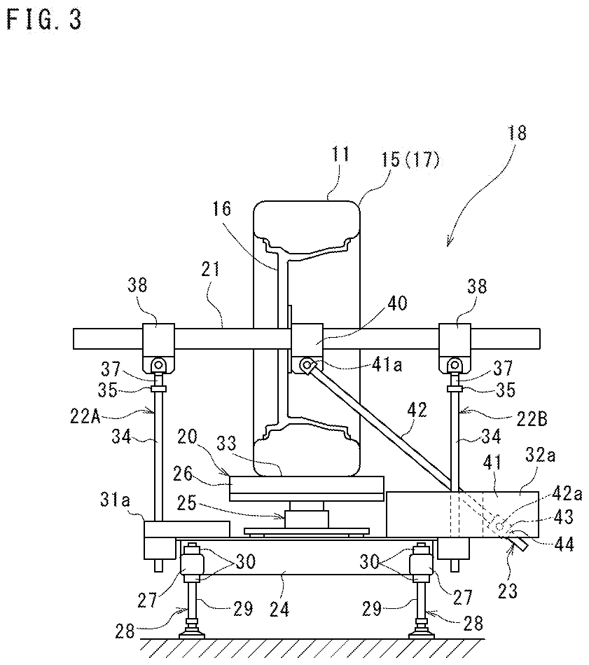

As shown in FIG. 3, the tire support device 18 includes a support base 20 on which part of an outer peripheral surface of the product tire 15 abuts, a support member 21 for supporting the product tire 15, and a longitudinal load application mechanism including a pair of longitudinal load application members 22A and 22B for holding the product tire 15 between itself and the support base 20 with the support member 21 interposed between them, and a lateral load application member 23 for pulling the product tire 15 in a horizontal direction via the support member 21.

The support base 20 includes a base 24, a load cell 25, and a support plate 26.

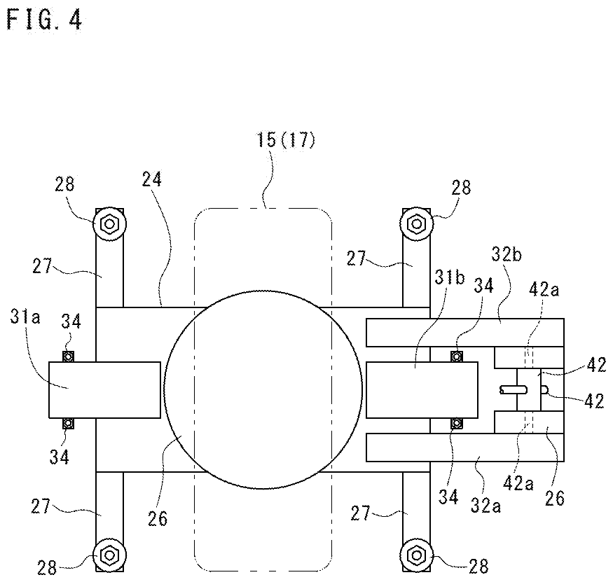

Referring also to FIG. 4, the base 24 is configured with a plate-like body having a rectangular shape in plan view. Extending portions 27 extend from four corners of the base 24 in the horizontal direction (vertical direction in FIG. 4) on both sides. A height adjusting member 28 is attached to a tip portion of each of the extending portions 27. In the present embodiment, the height adjusting member 28 is configured with a rod 29 vertically penetrating the tip portion of each of the extending portions 27, and a pair of upper and lower nuts 30 threadedly engaged with a male screw formed on an outer peripheral surface of the rod 29. By changing a screwing position of the nuts 30 sandwiching the extending portion 27, a projecting dimension of the rod 29 toward a lower side from the extending portion 27 can be adjusted. Here, the height adjusting member 28 is used for adjusting an inclination angle of the support plate 26. That is, by changing positions of the nuts 30 on the rods 29 in two locations positioned in one or both sides in a tire width direction, an inclination angle of the support plate 26 can be adjusted. A lower end portion of the rod 29 is expanded in a circular shape so that a state of placement on the ground is stabilized.

Fixed blocks 31a, 31b are fixed to both end sides on an upper surface of the base 24. A lower end portion of the longitudinal load application member 22A described later is fixed to the fixed block 31a on one side and a lower end portion of the longitudinal load application member 22B is connected to the fixed block 31b on the other side. Further, on one end side on an upper surface of the base 24, auxiliary blocks 32a and 32b are fixed to both sides of the fixed block 31b. Lower end portions of connecting rods 34 of the lateral load application member 23 described later are connected to the auxiliary blocks 32a and 32b.

A load cell 25 is fixed between the base 24 and the support plate 26. The load cell 25 expands a deformation amount caused by a load acting on the support plate 26, converts it into an electric signal by a strain gauge (not shown), and outputs it to a control device (not shown). The control device calculates the load acting on the support plate 26 based on the input electric signal from the strain gauge.

The support plate 26 is made from a material excellent in permeability, such as wood, acrylic, or the like, that is, a material in which a transmitted X-ray is hardly attenuated. The upper surface of the support plate 26 serves as a support surface 33 against which part of the tread portion 11 of the product tire 15 abuts. An inclination angle of the support plate 26 with respect to a horizontal plane can be adjusted by the height adjusting member 28 provided on the base 24. Here, a tread surface of the placed product tire 15 is inclined with respect to the horizontal plane in the tire width direction.

The support member 21 is a cylindrical body made from a metal material, such as stainless steel. Both end portions of the support member 21 are connected to the fixed blocks 31a and 31b of the support base 20 by the longitudinal load application members 22A and 22B which will be described later. The product tire 15 is attached to the support member 21. The product tire 15 is fixed to the wheel 16 with a first attachment portion 40 described later interposed between them in a state in which the support member 21 is inserted through a center hole of the attached wheel 16. A load can be applied to the product tire 15 toward the support surface 33 of the support plate 26 via the support member 21 by the longitudinal load application members 22A and 22B.

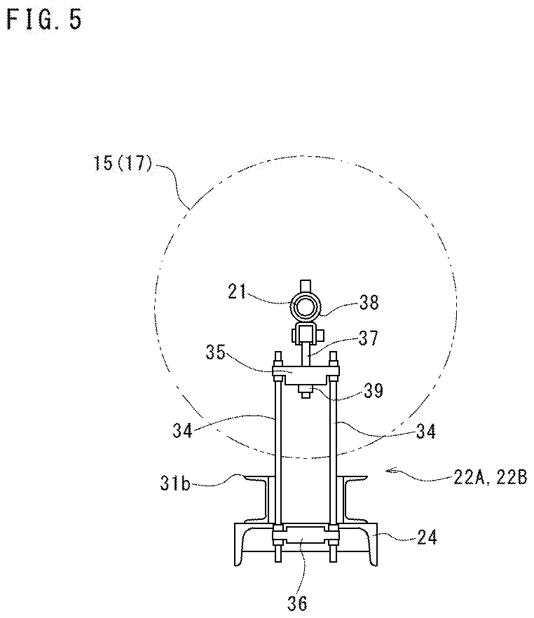

The longitudinal load application members 22A and 22B constituting the longitudinal load applying mechanism connect both end sides of the support member 21 and the support base 20 in such a manner that a length between them is adjustable. The longitudinal load application members 22A and 22B are disposed in both end portions in a longitudinal direction of the support plate 26. With reference also to FIG. 5, each of the longitudinal load application members 22A and 22B includes a pair of the connecting rods 34 arranged at predetermined intervals, a first connecting portion 35 connecting the connecting rods 34 in an upper end portion, and a second connecting portion 36 connecting them in a lower end portion. The first connecting portion 35 is connected to a support ring 38 attached to the support member 21 with a longitudinal shaft portion 37 interposed between them. A male screw is formed on an outer peripheral surface of the longitudinal shaft portion 37 and is threadedly engaged with a nut 39 in a lower side after passing through the first connecting portion 35. By changing the screwing position of the nut 39 at the longitudinal shaft portion 37, a tensile force acting on the support member 21 can be adjusted.

The lateral load application member 23 includes an inclined shaft portion 42 connected between a first attachment portion 40 fixed to the outer periphery of the support member 21 and a second attachment portion 41 fixed to the auxiliary blocks 32a and 32b. One end portion of the inclined shaft portion 42 is connected to the first attachment portion 40 so as to be rotatable around a support shaft 41a. The second attachment portion 41 is provided with a bearing portion 43 which is rotatable around a support shaft 42a. A male screw is formed on an outer peripheral surface of the other end portion of the inclined shaft portion 42. The inclined shaft portion 42 is caused to pass through the bearing portion 43 in a state where the other end portion is slidable in an axial center direction. A nut 44 is threadedly engaged with the inclined shaft portion 42 in a projecting portion from the bearing portion 43. By Changing the screwing position of the nut 44 on the inclined shaft portion 42, a tensile force acting on the support member 21 can be adjusted. That is, it is possible to set a load in a lateral (horizontal) direction acting on the product tire 15 via the support member 21.

The X-ray CT device 19 includes an X-ray irradiation section 45 for irradiating the tire 17 with an X-ray and an X-ray detection section 46 for detecting an X-ray that has passed through the tire 17.

The X-ray irradiation section 45 is disposed on the side of the tire support device 18 so that the X-ray irradiation section 45 can irradiate the tire 17 with an X-ray in a direction orthogonal to or inclined with respect to a meridian section. Further, the X-ray detection section 46 is disposed on the opposite side of the X-ray irradiation section 45 with the tire support device 18 interposed between them (in FIG. 2, the X-ray irradiation section 45 and the X-ray detection section 46, which are seemingly arranged on both sides in the tire width direction, are actually arranged obliquely or in a direction orthogonal to the diagram). The longitudinal load application members 22A and 22B are mainly configured with the connecting rod 34 having a narrow wire diameter, and hardly attenuate an X-ray emitted from the X-ray irradiation section 45. Therefore, an internal structure of the tire 17, for example, the wire of the belt 9 can be appropriately detected.

Next, a method of detecting distortion of the tire 17 by the tire distortion detection device will be described.

As a preliminary step for detecting distortion of the tire 17, a portion 47 to be detected is formed on at least one surface of a plurality of tire components that becomes the green tire 1 (first step). For example, copper or a metal material haying a density close to copper (having a density of 6 to 10 g/cm³) can be used for the portion 47 to be detected. Further, a thickness of the portion 47 to be detected to be formed is preferably 0.1 to 5 mm. However, the thickness of the portion 47 to be detected is preferably 1 mm or smaller so as not to affect deformation of the tire 17. Further, a material and thickness of the metal material used for the portion 47 to be detected are preferably set so that a value obtained by multiplying the density (g/cm³) by the thickness (cm) is within the range of 0.1 to 5. Note that the position where the portion 47 to be detected is formed may be one of an outer surface and an inner surface of a tire component or both. Then, tire components are assembled to form the green tire 1 (green tire formation process), the product tire 15 is formed by vulcanizing and molding the green tire 1 (product, tire formation process), and, for the obtained product tire 15, a strain condition is detected by changing a load condition as described later second step).

As a tire component forming the portion 47 to be detected, there are the carcass ply 6 and the cap ply 10 constituting the belt reinforcing layer 8.

In a case where the portion 47 to be detected is provided on the carcass ply 6 or the cap ply 10, the portion 47 to be detected can be formed along a first direction which is a direction in which a cord 48 (carcass cord or cap ply cord) extends or a second direction which is orthogonal to the first direction. The portions 47 to be detected are formed in a plurality of rows, and a shape of the portion to be detected itself may be dotted or linear.

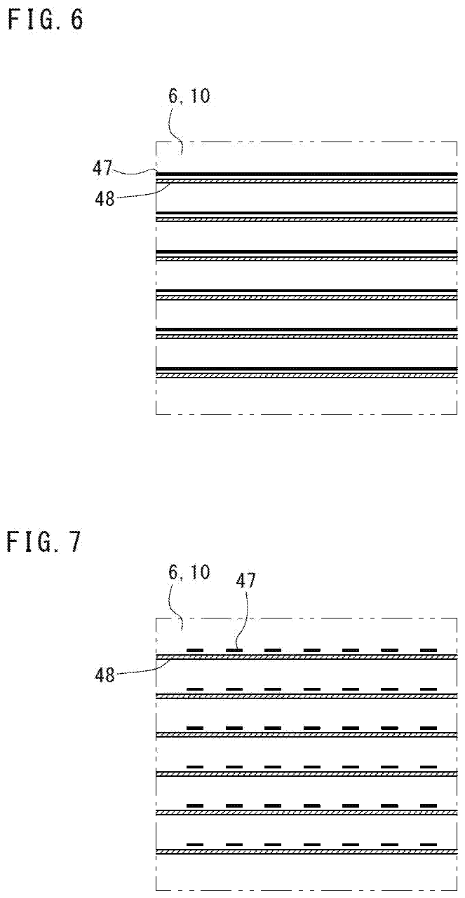

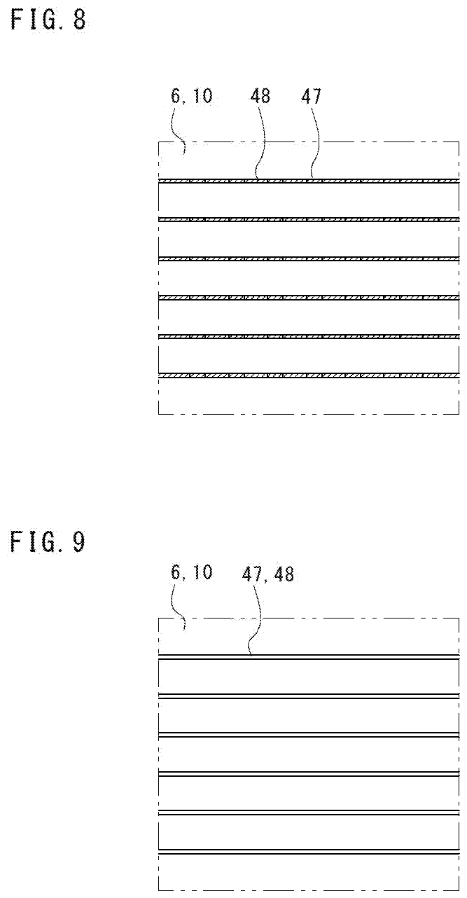

Specifically, FIGS. 6 to 9 show an example in which the portion 47 to be detected is fanned along the first direction in which the cord 48 extends. In FIG. 6, the portion 47 to be detected having a liner shape extending in the first direction is formed along the cord 48. In FIG. 7, the portion 47 to be detected having a dotted shape that extends in the first direction is foaled along the cord 48. In FIG. 8, the portion 47 to be detected is formed in a dot shape directly o the cord 48. In FIG. 9, the portion 47 to be detected is formed so as to directly cover the cord 48 directly in such a manner that the entire cord is covered. In a case where the portion 47 to be detected is formed directly on the cord, it is preferable to fix a metal material in a powder form to the cord. If an entire outer surface of the cord is covered with the metal material, deformation of the cord is affected, which makes it difficult to detect a deformation state of the entire tire which is originally required. Note that although the intervals at which the portions 47 to be detected are provided can be freely set, it is preferable to set the intervals according to the cord.

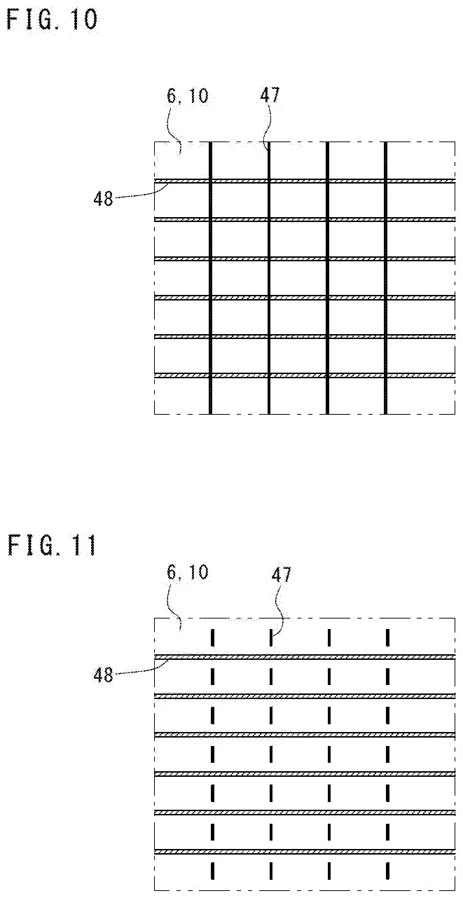

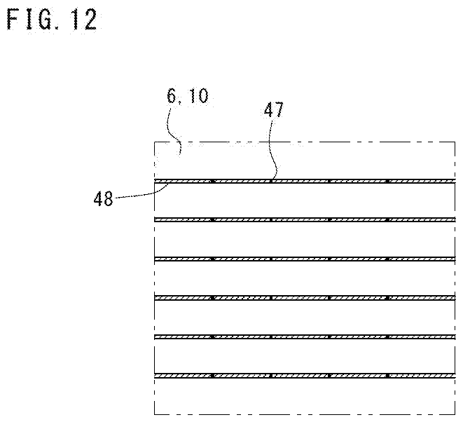

Further, FIGS. 10 to 12 show an example in which the portion 47 to be detected is formed in the second direction orthogonal to the extending direction of the cord. In FIG. 10, the portion 47 to be detected having a linear shape that extends in the second direction is formed. In FIG. 11, the portion 47 to be detected haying a dotted shape that extends in the second direction is formed. In FIG. 12, the portion 47 to be detected is formed in a dot shape directly on the cord. In this case, a length of the portion 47 to be detected in the first direction is preferably 10 mm or smaller, more preferably 5 mm or smaller, and is suitably 2 mm or smaller so as not to affect the deformation of the cord. Further, the length of the portion 47 to be detected in the second direction is not particularly specified, and may be the entire circumference or only a specific portion (for example, the tread portion 11) to be inspected. Note that, for example, in a case where the portion 47 to be detected is provided on the carcass ply 6, the intervals at which the portion 47 to be detected is provided may be set at 2 or more positions by which a section from an end portion of the belt layer 7 to the bead core 9 can be divided into three or more equal parts, and is preferably set to 9 or more positions by which the section can be divided into 10 equal parts or more.

In the present embodiment, distortion caused by the deformation of the tire 17 is detected for each of a case (first example) where the green tire 1 is vulcanized and molded to obtain the product tire 15 and a case (second example) where the wheel 16 is attached to the product tire 15 and the internal space is filled with air.

In the first example, how each part is deformed and distortion occurs between the green tire 1 and the product tire 15 obtained by vulcanizing and molding this green tire 1 is detected. In this strain detection, first, the, green tire 1 is attached to a dedicated fixing jig (not shown). Then, the X-ray irradiation section 45 irradiates the green tire 1 with an X-ray. A direction in which the irradiation with the X-ray is performed is set in a direction orthogonal to the meridian section of the green tire 1. However, the direction in which the irradiation with the X-ray is performed may be inclined with respect to the meridian section.

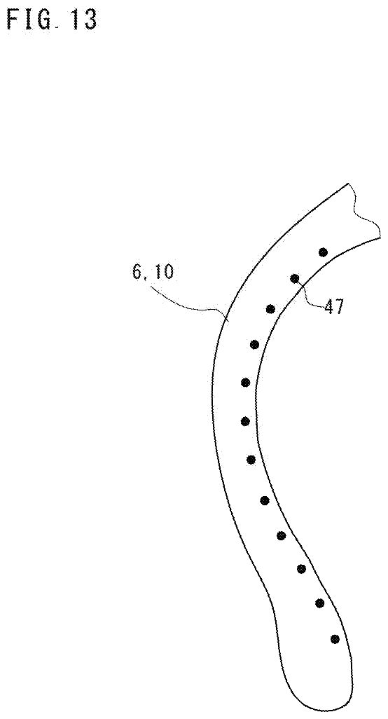

FIG. 13 is a schematic view (part of a tire meridian half cross-sectional view) of an image of the obtained green tire 1 in a case of the green tire 1 in which the portion 47 to be detected is formed along the second direction on the carcass ply 6. Before the vulcanization and molding, the portions 47 to be detected are detected at predetermined intervals in a curved direction along the meridian section shape of the green tire 1.

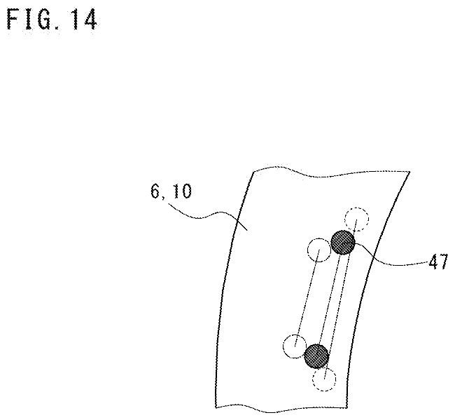

Subsequently, the green tire 1 is vulcanized and molded, and the obtained product tire 15 is mounted on the tire support device 18. However, as will be described later, if no longitudinal load or lateral load is applied to the product tire 15, the product tire 15 may be simply fixed to a tire stand or the like. In this case, it does not matter whether a wheel is mounted on the product tire 15 or not. Then, in a similar manner to that described above, an image of the product tire 15 is obtained by irradiation with an X-ray. As a result, as shown in FIG. 14, a portion (indicated by a two-dot chain line in the diagram) where space between the portions 47 to be detected is small and a portion (indicated by a dotted line in the diagram) where the space is large are generated. It can be determined that compressive strain is generated in a portion where space between the portions 47 to be detected is small. Further, it can be determined that tensile strain is generated in a portion where space between the portions 47 to be detected is large. Specifically, such strains are preferably calculated based on a change in length of a line segment obtained by polynomial interpolation, a change in length of a curve obtained by spline interpolation, or the like. This makes it possible to detect a state of generation of strain in the tire meridian section of the carcass ply 6 of the green tire 1.

Further, in a case where the portion 47 to be detected is formed directly on the cord 48, strain in a direction in which the portion 47 to be detected extends can be calculated from a change in length of the portion 47 to he detected itself. Furthermore, since tensile strength is known from a material of the cord 48, stress (tension) acting on the cord 48 may also be calculated based on a deformation amount of the portion 47 to be detected.

In the second example, how each part deforms and distortion is generated is detected in a non-pressure state in which only the wheel 16 is attached to the product tire 15 and in a pressurized (inflated) state in which the internal space of the product tire 15 is filled with air until a desired internal pressure is reached. As in the case of FIG. 10, in an example where the portion 47 to be detected is formed along the second direction on the carcass ply 6, it can be determined that compressive strain is generated in a portion where space between the portions 47 to be detected is small, and tensile strain is generated in a portion when space between the portions 47 to be detected is large.

As described above, according to the above-described embodiment, the portion 47 to be detected made from a metal material is formed on the tire component. Accordingly, distortion inside the tire that has not been able to be detected conventionally can be detected.

It should be noted that the present mention is not limited to the configuration described in the above embodiment, and various modifications are possible.

The above embodiment describes a case of detecting distortion in the carcass ply 6 and the cap ply 10 in the green tire 1 or the product tire 15. However, it is also possible to detect distortion by forming the portion 47 to be detected even for a rubber component constituting the side wall portion 13 and the bead portion 14. In this case, the portion 47 to be detected may be formed on a surface of the rubber component. The portion 47 to be detected to be formed can be freely set to a mode, such as a planar shape, a linear shape, a dot shape, a lattice shape, and the like, so that distortion in various directions can be detected. Further, the number of tire components forming the portion 47 to be detected is not limited to one, and may be two or more.

In the above-described embodiment, distortion between before and after vulcanization molding or distortion between before and after inflation is detected. Alternatively, distortion may be detected, including the above two cases, between any two of the following states: (1) a state of a tire portion; (2) a state of the green tire 1; (3) a no-load state in which no load is applied to the product tire 15; (4) a state in which the product tire 15 is inflated; (5) a state in which a longitudinal load is applied to the product tire 15; (6) a state in which a lateral load is applied to the tire 15; (7) a state in which a load is applied to the product tire 15 in a front-rear direction; (8) a state in which the product tire 15 is freely rolled (no rotational torque is acting); (9) a state in which a braking force is applied to the product tire 15 so as to roll the product tire 15; (10) a state in which a driving force is applied to the product tire 15 so as to roll the product tire 15; and (11) a state in which the product tire 15 is turned (a state in which the product tire 15 is rolled at a slip angle).

For example, distortion caused by other deformations, such as deformation between before and after grounding of the product tire 15 (deformation between (4) and (5) above), deformation between before and after a lateral load is applied to the product tire 15 (deformation between (4) and (6) above), and the like, may be detected.

In the deformation between before and after grounding, a change in the position of the portion 47 to be detected between a case where no load is applied to the product tire 15 by the longitudinal load application members 22A and 22B and a case where the load is applied is preferably detected in a similar manner to that described above.

In the deformation between before and after the lateral load is applied to the product tire 15, while a load is applied to the product tire 15 by the longitudinal load application members 22A and 22B, a change in the position of the portion 47 to be detected between a case where no lateral load is further applied by the lateral load application member 23 and a case where the lateral load is applied is preferably detected in a similar manner to that described above.

In the above embodiment, the portion 47 to be detected is detected by irradiation with an X-ray. However, the present invention is not limited to the above configuration, and magnetic resonance imaging (MRI) or ultrasonic detection may be employed for the detection.

In the above embodiment, the carcass ply 6 and the cap ply 10 are described as tire components forming the portion 47 to be detected. However, other than the rubber layer of the tread portion 11, the side wall portion 13 and the bead portion 14 without a wire, the belt 9 using a steel wire may be used.

What is claimed is:

1. A tire distortion detection method, comprising:
a first step of forming a metallic portion to be detected in a plurality of locations of at least one of tire components;
a second step of detecting the portion to be detected in any two states from a formation of a product tire from the tire component to a change of a load condition on the product tire; and
a third step of comparing positions of the respective portions to be detected in the two states obtained in the second step.

2. The tire distortion detection method according to claim 1, wherein
the second step includes a green tire formation process of assembling a plurality of tire components including the tire component to form a green tire, and a product tire formation process of forming a product tire by vulcanizing and molding the green tire, and
in the third step, positions of respective portions to be detected that are detected after completion of the green tire formation process and the product tire formation process are compared.

3. The tire distortion detection method according to claim 1, wherein
the second step includes a product tire formation process of vulcanizing and molding the green tire to form a product tire, and
in the third step, a position of each portion to be detected that is detected when a product tire obtained in the product tire formation process is in a no-load state, and a position of each portion to be detected that is detected when a product tire is inflated by increasing an air pressure in internal space of the product tire are compared.

4. The tire distortion detection method according to claim 1, wherein the portions to be detected are formed in a dotted or linear shape and arranged at predetermined intervals.

5. The tire distortion detection method according to claim 2, wherein the portions to be detected are formed in a dotted or linear shape and arranged at predetermined intervals.

6. The tire distortion detection method according to claim 3, wherein the portions to be detected are formed in a dotted or linear shape and arranged at predetermined intervals.

7. The tire distortion detection method according to claim 1, wherein
the tire component includes a plurality of tire cords provided m parallel at predetermined intervals, and
the portions to be detected are provided in parallel in a direction orthogonal to a direction in which the tire cord extends, and extend in a dotted or linear shape in a direction along the tire cord.

8. The tire distortion detection method according to claim 2, wherein
the tire component includes a plurality of tire cords provided in parallel at predetermined intervals, and
the portions to be detected are provided in parallel in a direction orthogonal to a direction in which the tire cord extends, and extend in a dotted or linear shape in a direction along the tire cord.

9. The tire distortion detection method according to claim 3, wherein
the tire component includes a plurality of tire cords provided in parallel at predetermined intervals, and
the portions to be detected are provided in parallel in a direction orthogonal to a direction in which the tire cord extends, and extend in a dotted or linear shape in a direction along the tire cord.

10. The tire distortion detection method according to claim 4, wherein
the tire component includes a plurality of tire cords provided in parallel at predetermined intervals, and
the portions to be detected are provided in parallel in a direction orthogonal to a direction in which the tire cord extends, and extend in a dotted or linear shape in a direction along the tire cord.

11. The tire distortion detection method according to claim 5, wherein
the tire component includes a plurality of tire cords provided in parallel at predetermined intervals, and
the portions to be detected are provided in parallel in a direction orthogonal to a direction in which the tire cord extends, and extend in a dotted or linear shape in a direction along the tire cord.

12. The tire distortion detection method according to claim 6, wherein
the tire component includes a plurality of tire cords provided in parallel at predetermined intervals, and
the portions to be detected are provided in parallel in a direction orthogonal to a direction in which the tire cord extends, and extend in a dotted or linear shape in a direction along the tire cord.

13. The tire distortion detection method according to claim 1, wherein
the tire component includes a plurality of tire cords provided in parallel at predetermined intervals, and
the portions to be detected are provided in parallel in a direction in which the tire cord extends, and extend in a dotted or linear shape in a direction orthogonal to a direction in which the tire cord extends.

14. The tire distortion detection eth d according to claim 2, wherein
the tire component includes a plurality of tire cords provided in parallel at predetermined intervals, and
the portions to he detected are provided in parallel in a direction in which the tire cord extends, and extend in a dotted or linear shape in a direction orthogonal to a direction in which the tire cord extends.

15. The tire distortion detection eth d according to claim 3, wherein
the tire component includes a plurality of tire cords provided in parallel at predetermined intervals, and
the portions to be detected are provided in parallel in a direction in which the tire cord extends, and extend in a dotted or linear shape in a direction orthogonal to a direction in which the tire cord extends.

16. The tire distortion detection method according to claim 4, wherein
the tire component includes a plurality of tire cords provided in parallel at predetermined intervals, and
the portions to be detected are provided in parallel in a direction in which the tire cord extends, and extend in a dotted or linear shape in a direction orthogonal to a direction in which the tire cord extends.

17. The tire distortion detection method according to claim 5, wherein
the tire component includes a plurality of tire cords provided in parallel at predetermined intervals, and
the portions to be detected ate provided in parallel in a direction in which the tire cord extends, and extend in a dotted or linear shape in a direction orthogonal to a direction in which the tire cord extends.

18. The tire distortion detection method according to claim 6, wherein
the tire component includes a plurality of tire cords provided in parallel at predetermined intervals, and
the portions to be detected are provided in parallel in a direction in which the tire cord extends, and extend in a dotted or linear shape in a direction orthogonal to a direction in as the tire cord extends.

19. A green tire having a tire component in which a metal portion to be detected that is detectable by detecting means is formed in a plurality of locati
